(19) United States
(12) Patent Application Publication
(10) Pub. No.: US 2024/0237616 A1
(43) Pub. Date: Jul. 18, 2024

(54) PET TREAT FOR STORING IN A WALLET

(71) Applicant: Mark Zapata, Lubbock, TX (US)

(72) Inventor: Mark Zapata, Lubbock, TX (US)

(21) Appl. No.: 18/097,823

(22) Filed: Jan. 17, 2023

(51) Int. Cl. A01K 15/02

(52) U.S. Cl. CPC A01K 15/026

(57) ABSTRACT

A pet treat for storing in a wallet includes a card comprising a chewable material. The card the card has a pair of ends, a pair of lateral edges, and a pair of surfaces. Each of the pair of lateral edges extend between the pair of ends, and each of the pair of surfaces extend between the pair of ends and the pair of lateral edges. A length between the pair of ends is less than 4.0 inches, a width between the pair of lateral edges is less than 3 inches, and a thickness between the pair of surfaces is less than 0.15 inches such that the card is configured for inserting into a card sleeve of a wallet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet treats and more particularly pertains to a new pet treat for storing in a wallet.

### (2) Description of Related Art Including Information Disclosed Under 37 CFR 1.97 and 1.98

The prior art relates to pet treats, including myriad compositions of pet treats for achieving particular textural and nutritional requirements and providing dental care for an animal. However, the prior art collectively fails to address a pet treat being structured for storage within a wallet.

### BRIEF SUMMARY OF THE INVENTION

An embodiment of the disclosure meets the needs presented above by generally comprising a card comprising a chewable material. The card the card has a pair of ends, a pair of lateral edges, and a pair of surfaces. Each of the pair of lateral edges extend between the pair of ends, and each of the pair of surfaces extend between the pair of ends and the pair of lateral edges. A length between the pair of ends is less than 4.0 inches, a width between the pair of lateral edges is less than 3 inches, and a thickness between the pair of surfaces is less than 0.15 inches such that the card is configured for inserting into a card sleeve of a wallet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a pet treat according to an embodiment of the disclosure.

FIG. 2 is a front view of an embodiment of the disclosure.

FIG. 3 is a rear view of an embodiment of the disclosure.

FIG. 4 is an in-use view of an embodiment of the disclosure.

### DETAILED DESCRIPTION OF THE INVENTION

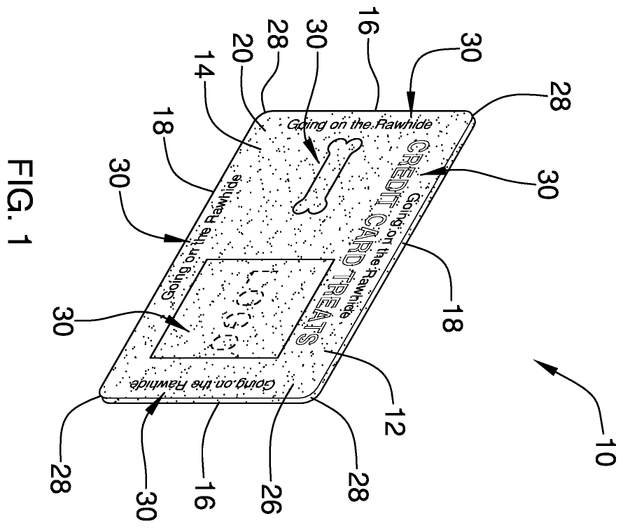

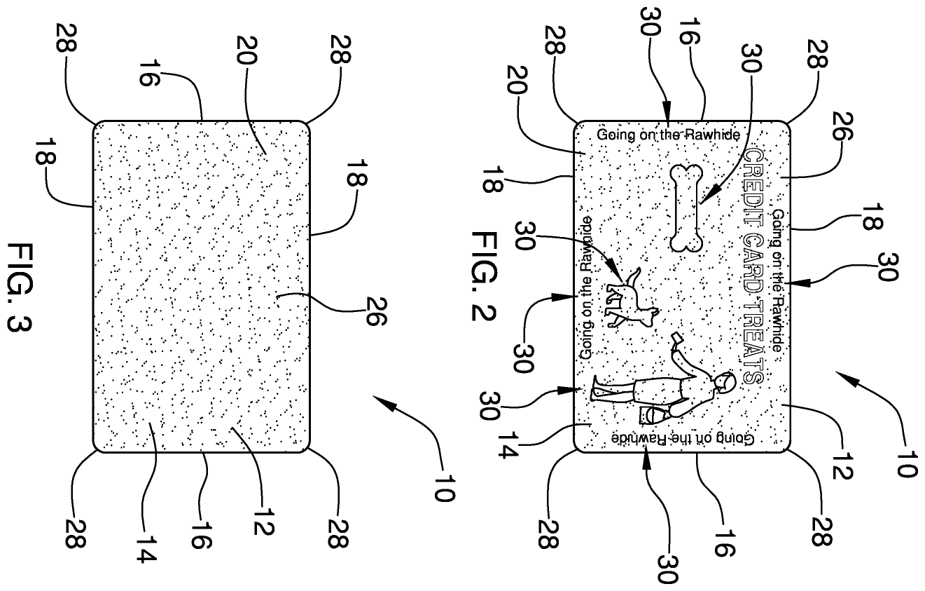

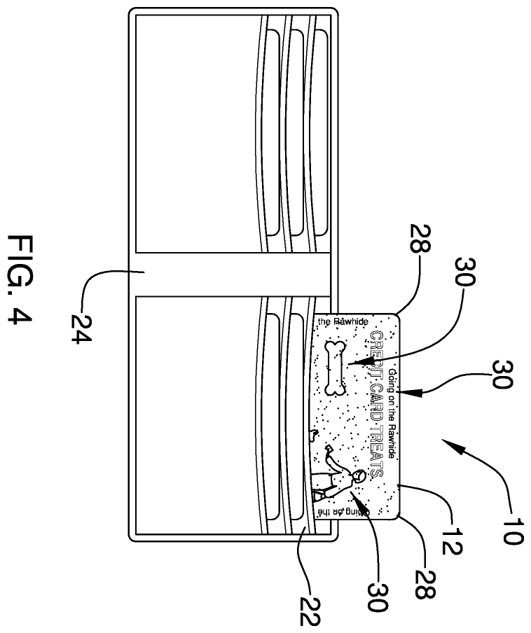

With reference now to the drawings, and in particular to FIGS. 1 through 4 thereof, a new pet treat embodying the principles and concepts of an embodiment of the disclosure and generally designated by the reference numeral 10 will be described.

As best illustrated in FIGS. 1 through 4, the pet treat 10 generally comprises a card 12 comprising a chewable material 14. A “chewable material” as used in the specification and the claims is a material which an animal is capable of chewing. The chewable material 14 may be resilient such that the chewable material 14 retains or elastically resumes an initial shape when being chewed by the animal. The chewable material 14 also may be plastically deformable such that the chewable material 14 takes on a new shape upon being chewed by the animal. The chewable material 14 also may be breakable such that it crumbles or tears when chewed by the animal. The chewable material 14 may include edible material which the animal consumes and may include flavorings and aromatic elements to attract the animal to chew the chewable material 14.

The chewable material 14 may comprise one or more of rawhide, an animal hoof, an animal bone, a biscuit, dehydrated meat, a dehydrated vegetable, a dehydrated fruit, and kibble. A “biscuit” as used in the specification and the claims is a product of heat curing a mixture containing flour to maintain a set shape. “Kibble” as used in the specification and the claims is a coarsely ground meal or grain which is compressed or molded to maintain a particular shape.

The card 12 has a pair of ends 16, a pair of lateral edges 18, and a pair of surfaces 20. Each of the pair of lateral edges 18 extend between the pair of ends 16, and each of the pair of surfaces 20 extend between the pair of ends 16 and the pair of lateral edges 18. A length between the pair of ends 16 is between 2.5 inches and 3.5 inches, a width between the pair of lateral edges 18 is between 1.5 inches and 2.5 inches, and a thickness between the pair of surfaces 20 is less than 0.05 inches such that the card 12 is configured for inserting into a card sleeve 22 of a wallet 24. The card 12 has a rectangular shape 26. The card 12 has a plurality of corners 28, each of which is positioned between an associated one of the ends 16 and an associated one of the lateral edges 18. Each corner 28 is rounded.

An indicia 30 is positioned on one of the surfaces 20 of the card 12. “Indicia” as used in the specification and the claims is used for the singular and plural forms of the word. The indicia 30 may include identifying marks which inform a viewer that the card 12 is a treat for a pet. The indicia 30 may also inform a viewer of the particular composition of the card 12 including the types of flavorings incorporated into the card 12, if any. The indicia 30 may also indicate the business source of the card 12. The indicia 30 may include one or more of a graphic, text, symbol, logo, number and the like. An ornamental design may also be included in the indicia 30. In some embodiments, the indicia 30 are printed on the card 12. In other embodiments, the indicia 30 are integrally formed with the card 12. In such other embodiments, the card 12 is embossed, engraved, molded, or the like to form the indicia 30.

In use, the pet treat 10 is stored in the card sleeve 22 of the wallet 24. The pet treat 10 may then be given to the animal as desired to chew and possibly consume.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet treat comprising a card, said card comprising a chewable material, said card said card having a pair of ends, a pair of lateral edges, and a pair of surfaces, each of said pair of lateral edges extending between said pair of ends, each of said pair of surfaces extending between said pair of ends and said pair of lateral edges, a length between said pair of ends being less than 4.0 inches, a width between said pair of lateral edges being less than 3 inches, a thickness between said pair of surfaces being less than 0.15 inches such that said card is configured for inserting into a card sleeve of a wallet.

2. The pet treat of claim 1, further comprising said length being between 2.5 inches and 3.5 inches.

3. The pet treat of claim 1, further comprising said width being between 1.5 inches and 2.5 inches.

4. The pet treat of claim 1, further comprising said thickness being less than 0.05 inches.

5. The pet treat of claim 1, further comprising said card having a rectangular shape.

6. The pet treat of claim 1, further comprising said card having a plurality of corners, each said corner being positioned between an associated one of said ends and an associated one of said lateral edges, each said corner being rounded.

7. The pet treat of claim 1, further comprising an indicia being positioned on one of said surfaces of said card.

8. The pet treat of claim 7, further comprising said indicia being printed on said card.

9. The pet treat of claim 7, further comprising said indicia being integrally formed with said card.

10. The pet treat of claim 1, further comprising said chewable material comprising rawhide.

11. The pet treat of claim 1, further comprising said chewable material comprising an animal hoof.

12. The pet treat of claim 1, further comprising said chewable material comprising an animal bone.

13. The pet treat of claim 1, further comprising said chewable material comprising a biscuit.

14. The pet treat of claim 1, further comprising said chewable material comprising dehydrated meat.

15. The pet treat of claim 1, further comprising said chewable material comprising a dehydrated vegetable.

16. The pet treat of claim 1, further comprising said chewable material comprising a dehydrated fruit.

17. The pet treat of claim 1, further comprising said chewable material comprising kibble.

18. A pet treat comprising:
a card comprising a chewable material, said card having a pair of ends, a pair of lateral edges, and a pair of surfaces, each of said pair of lateral edges extending between said pair of ends, each of said pair of surfaces extending between said pair of ends and said pair of lateral edges, a length between said pair of ends being between 2.5 inches and 3.5 inches, a width between said pair of lateral edges being between 1.5 inches and 2.5 inches, a thickness between said pair of surfaces being less than 0.05 inches such that said card is configured for inserting into a card sleeve of a wallet, said card having a rectangular shape, said card having a plurality of corners, each said corner being positioned between an associated one of said ends and an associated one of said lateral edges, each said corner being rounded; and
an indicia being positioned on one of said surfaces of said card.

19. The pet treat of claim 18, further comprising said indicia being printed on said card.

20. The pet treat of claim 18, further comprising said indicia being integrally formed with said card.
